(19) United States
(12) Patent Application Publication
(10) Pub. No.: US 2014/0103766 A1
(43) Pub. Date: Apr. 17, 2014

(54) CENTRIFUGAL DYNAMIC POWER GENERATING SYSTEM USING A LEVER STRUCTURE

(71) Applicants: Jhao-Tang Huang, Taipei Hsien (TW); His-Liang Chiu, Taipei (TW)

(72) Inventors: Jhao-Tang Huang, Taipei Hsien (TW); His-Liang Chiu, Taipei (TW)

(21) Appl. No.: 13/653,416

(22) Filed: Oct. 17, 2012

(51) Int. Cl. H02K 7/00

(52) U.S. Cl. CPC H02K 7/003; Y10S 74/09; H02K 53/00
USPC 310/113; 74/DIG. 9

(57) ABSTRACT

A centrifugal dynamic power generating system using a lever structure is provided. A motor is used to drive a transversal shaft and then the transversal shaft will drive a lever. The lever will further drive a heavy ball. Then the heavy ball drives a centrifugal unit. The centrifugal force from the centrifugal unit causes the power to be transferred to a power generating unit. Through the driving flywheel, the power is transferred to the power generator to be converted into electric power. By above mentioned structure, the power is enhanced one unit to next unit. As a result, mechanic power is converted to electric power. Advantages of the present invention are that only a small area is need. The process for generating power is safe and without any pollution to environment. The voltage and frequency generated are steady with a lower cost. Therefore, the present invention can effectively replace conventional power generating systems.

### FIELD OF THE INVENTION

The present invention relates power generation, and in particular to a centrifugal dynamic power generating system using a lever structure.

### BACKGROUND OF THE INVENTION

Conventional power generator, such as a wind power generator, could generate a power of 3-5 tons, a fossil power generator could generate a power of 10-20 tons, a solar power generator generates a power of 5 tons, and a nuclear power generator generates a power of 30-50 tons. However, above mentioned power generators consume large amount of energies and dynamic powers. If there is a novel power generator which generates sufficient power with only small amount of power consumptions, it will be highly efficient and widely acceptable to peoples.

In conventional power generation systems, huge power plants are built and their structures are very complicated. Professional designs and large capitals are necessary, while these are not acceptable by small and medium sized enterprises. Although solar or wind power generations are suitable for lower cost investment and for the necessity of small power, they are confined by many rules or practical conditions, for example, solar power generation needs a great area and is limited by amount of sunshine. Furthermore, the cost of solar power generation is higher than the current used fossil fuel power generators. Wind power generation is also limited by wind of the area installed the generators and it only generates finite power. Therefore, current used power sources still have many limitations which cannot resolve current problems in environment protection and cannot overcome the problem from safety consideration. Thus, the inventor of the present invention is eager to have a novel design which can overcome the problems of current power generations.

Applicants of the present invention have disclosed some inventions for resolve the problems of prior power generation, one is Taiwan Patent Application No. 100209244, “Oil pressure power generation system”; and the other is Taiwan Patent Application NO. 100209214, “auto-power feedback power generator. However, these two designs cannot generate a sufficient larger power. Nowadays, the applicant disclose a novel one which can improve the defects in the former two applications and resolve the defects in the prior arts and can be used replaced conventional power generation systems.

### SUMMARY OF THE INVENTION

Therefore, the object of the present invention is to resolve the defects in the prior art. The present invention discloses a centrifugal dynamic power generating system using a lever structure, in that a motor is used to drive a lever and then the lever is used to drive a centrifugal shaft to generate a larger twisting force. This force is further transferred to a power generator. A part of the output power is feedback to drive the motor. The power is reused circularly. Advantages of the present invention are that only a small area is needed. The system has no pollution and is safe. The output voltages and frequencies are steady and the cost is low.

To achieve above object, the present invention provides a centrifugal dynamic power generating system by using a lever structure, comprising: a dynamic unit as a power supply of the system; in the dynamic unit, a power source being connected to a motor for actuating the motor; a lever unit connected to the dynamic unit for transferring power of the dynamic unit to next element by a lever to provide a greater arm of force and thus output powers being enhanced; a centrifugal unit connected to the lever unit; twisting force from the lever unit will drive a weight at an outer edge of the centrifugal unit; a bottom end of a central portion of the centrifugal unit being supported so that the centrifugal unit is rotatable around an supporting point through 360 degrees to generate a great twisting force; a power generating unit connected to the centrifugal unit; power of the centrifugal unit will be transferred to the power generating unit to drive a spindle of a power generator to generate power; and wherein by above mentioned structure, mechanic power from the motor is enhanced from one unit to a next one; and finally, the mechanic power is transferred to electric power so as to have a larger power generation; and only a small area is needed without any pollution and with steady voltage and frequency.

### BRIEF DESCRIPTION OF THE DRAWINGS

FIG. 1 is a block diagram of the present invention.

FIG. 2A is a schematic view of the present invention.

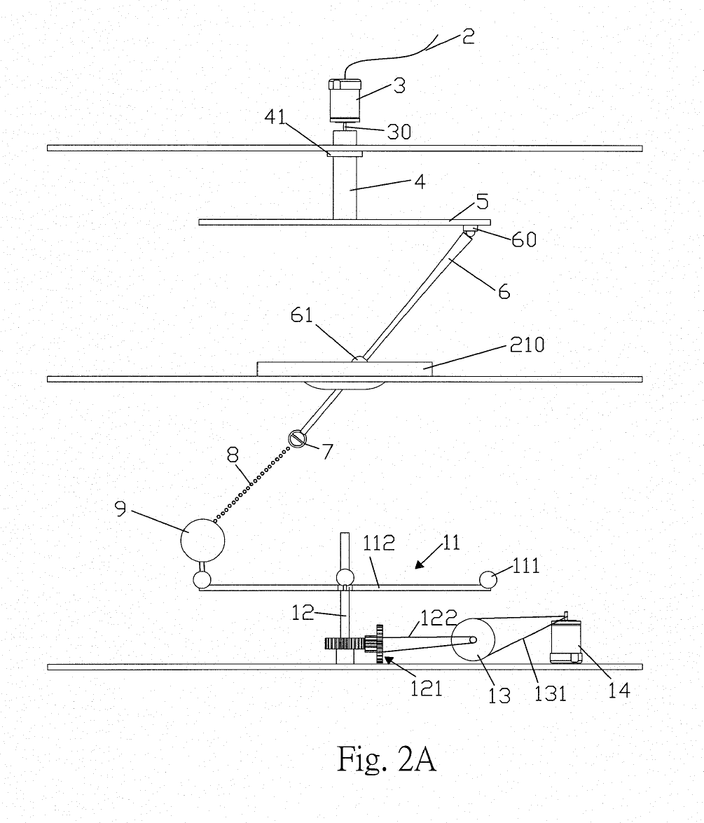

FIG. 2B is a perspective view of the present invention.

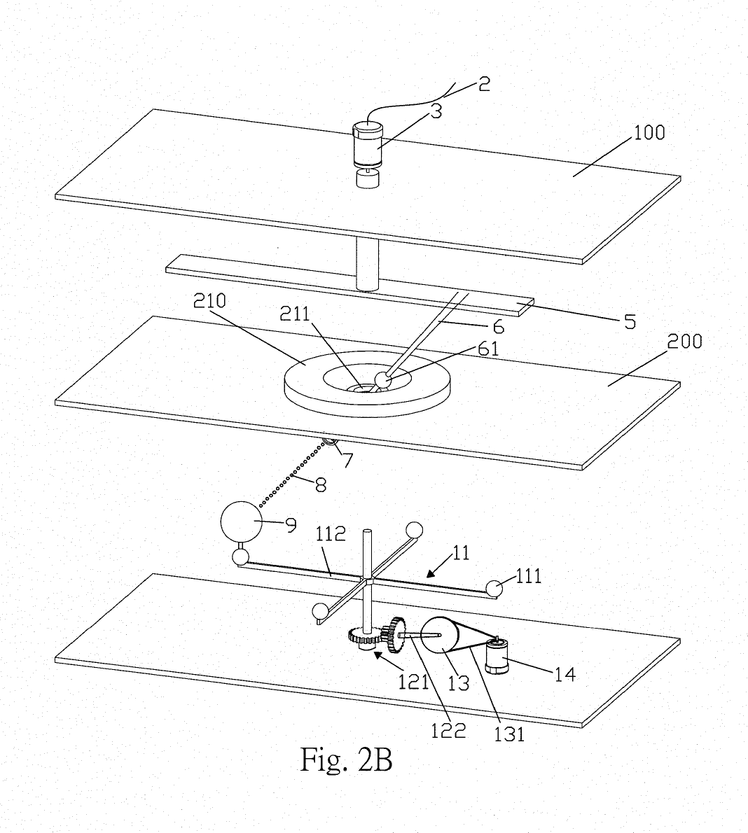

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

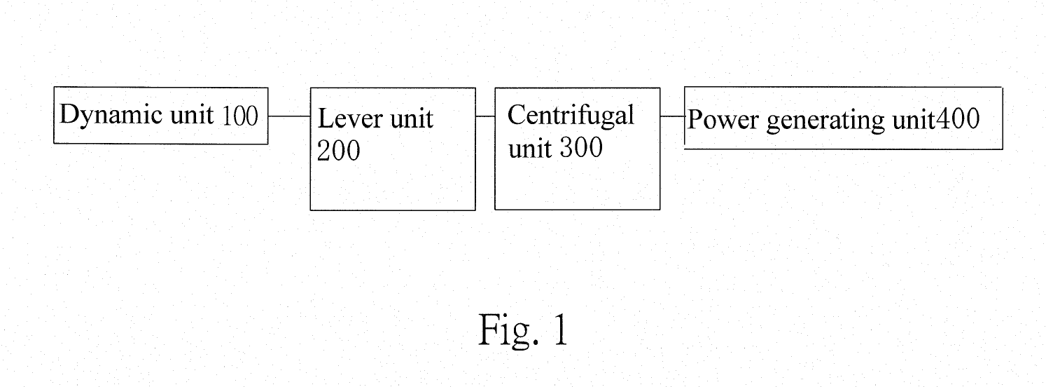

With reference to FIG. 1, the centrifugal dynamic power generator by lever structure according to the present invention is illustrated. The present invention has the following elements.

A dynamic unit 100 is used to supply power to the whole system. In the dynamic unit 100, a power source is connected to a motor 3 for actuating the motor 3. Then the motor 3 serves to drive other elements of the system. The dynamic unit 100 includes the following elements.

A power source 2 serves to supply power to a motor 3.

The motor 3 serves to supply power to other elements of the system. The motor 3 has a spindle 30 and is installed on an upper plate 110.

A lever unit 200 is connected to the dynamic unit 100 for transferring power of the dynamic unit 100 to next element by a lever structure to provide a large arm of force and thus output powers are enhanced. The lever unit 200 has the following elements.

An upper shaft 4 has an upper end which is connected to the spindle 30 of the motor 3. The upper shaft 4 passes through the upper plate 110 and is supported thereto by a bearing 41.

A transversal shaft 5 has a central portion connected to a lower end of the upper shaft 4. As a result, when the motor 3 is actuated, the spindle 30 of the motor 3 will drive the upper shaft 4 to rotate and then the upper shaft 4 drives the transversal shaft 5 to rotate.

A lever 6 has an approximate tapered shaft (as illustrated in the drawings, but the taper shape of the lever 6 is not used to confine the scope of the present invention). An upper end of the lever 6 is retained to a distal end of the transversal shaft 5 by using a lever bearing 60 so that the lever 6 is rotatable through 360 degrees with respect to the transversal shaft 5. A middle section of the lever 6 is expanded as an expending ball 61.

In installation, the expending ball 61 is received within a bowl unit 210. A bottom of the bowl unit 210 has a through hole 211 so that a lower portion of the lever 6 below the ball 61 passes through the through hole 211 of the bowl unit 210. When the lever 6 rotates around the transversal shaft 5, the bowl unit 210 will support the ball 61 and the lever 6 is driven to rotate around the expanding ball 61 supported on the bowl unit 210. In use, the bowl unit 210 is installed to a middle plate 220 (which may be a plate of steel rods).

A lower end of the lever 6 is connected to an adjustable sleeve 7.

A heavy ball 9 may be an iron ball, a steel ball or other metal ball. The heavy ball 9 is connected to a lower end of a steel rope 8. An upper end of the steel rope 8 is connected to the adjustable sleeve 7. The adjustable sleeve 7 causes to the steel rope 8 will not twist around the lever 6 as the adjustable sleeve 7 rotates with respect to the lever 6. Therefore, rotation of the lever 6 will drive the heavy ball 9 to rotate through a large circle. In the present invention, the heavy ball 9 may be a steel ball of 1 to 100 T or a large one.

A centrifugal unit 300 is connected to above lever unit 200. The twisting force from the lever unit 200 will drive a weight 111 at an outer edge of the centrifugal unit 300. A bottom end of a central portion of the centrifugal unit 300 is supported so that the centrifugal unit 300 is rotatable around a supporting point through 360 degrees so as to generate a great twisting force.

In the present invention, the centrifugal unit 300 includes the following elements.

At least one centrifugal shaft 112 is included. In this embodiment, two centrifugal shafts 112 are illustrated. However, the number of the centrifugal shafts 112 are not limited to two The two centrifugal shafts 112 run across one another so as to have a cruciform shape. One end of one of the two centrifugal shafts 112 is installed with a weight 111 which is connected to the heavy ball 9 by another steel rope. When the heavy ball 9 is driven to rotate by the lever 6, the weight 111 will rotate therewith. Therefore, the whole centrifugal unit 300 rotates. In this example the weight 111 is an iron ball of 1 to 10 tons.

A lower shaft 12 has one end connected to a center portion of the centrifugal unit 300. Another end of the lever 6 is received in a retainer seat 150 with a bearing (not shown) therein so that the lower shaft 12 can be rotatably retained to the retaining seat 150.

A power generating unit 400 is connected to the centrifugal unit 300. Power of the centrifugal unit 300 will be transferred to the power generating unit 400 to drive a spindle of a power generator to rotate and thus electric power is induced. The elements of the power generating unit 400 will be described therein.

A gear set 121 is installed to a lower end of the lower shaft 12. The gear set 121 is formed by using a longitudinal gear to engage with an umbrella gear. The umbrella gear is connected to one end of a driving shaft 122.

A driving flywheel 13 is connected to another end of the driving shaft 122. An outer edge of the driving flywheel 13 is encircled by one end of a belt 131. Rotation of the driving flywheel 13 will drive the belt 131 to run circularly.

A power generator 14 has a generator spindle which is encircled by another end of the belt 131. Thus rotation of the belt 131 will drive the generator spindle to rotate and thus the power generator 14 will generate power.

Therefore, in the present invention, a motor 3 is used to drive a transversal shaft 5 and then the transversal shaft 5 will drive a lever 6. By lever principle, the lever 6 will further drive a heavy ball 9. Then the heavy ball 9 further drives a centrifugal unit 300. The centrifugal force from the centrifugal unit 300 causes the power to be transferred to a next power generating unit 400. Through the driving flywheel 13, the power is transferred to the power generator 14 to be converted into electric power by the power generator 14. By above mentioned structure, the power is enhanced from one unit to next unit. As a result, the mechanic power is converted to electric power. Advantages of the present invention are that only a small area is need. The process for generating power is safe and without any pollution to environment. The voltage and frequency generated are steady with a lower cost. Therefore, the present invention can effectively replace conventional power generating systems.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A centrifugal dynamic power generating system using a lever structure, comprising;
a dynamic unit as a power supply of the system; in the dynamic unit, a power source being connected to a motor for actuating the motor;
a lever unit connected to the dynamic unit for transferring power of the dynamic unit to next element by a lever to provide a large arm of force and thus output powers being enhanced;
a centrifugal unit connected to the lever unit; twisting force from the lever unit will drive a weight at an outer edge of the centrifugal unit; a bottom end of a central portion of the centrifugal unit being supported so that the centrifugal unit is rotatable around an supporting point through 360 degrees to generate a great twisting force;
a power generating unit connected to the centrifugal unit; power of the centrifugal unit will be transferred to the power generating unit to drive a spindle of a power generator to generate power; and
wherein by above mentioned structure, mechanic power from the motor is enhanced from one unit to a next one; and finally, the mechanic power is transferred to electric power so as to have a larger power generation; only a small area is needed without any pollution and the electric power has steady voltage and frequency.

2. The centrifugal dynamic power generating system using a lever structure as claimed in claim 1, wherein the dynamic unit comprises:
a power source for supplying power to a motor;
the motor having a spindle and being installed on an upper plate.

3. The centrifugal dynamic power generating system using a lever structure as claimed in claim 2, wherein the lever unit comprises;
an upper shaft having an upper end which is connected to a spindle of the motor; the upper shaft passing through the upper plate and being supported thereto by a bearing;
a transversal shaft having a central portion connected to a lower end of the upper shaft; as a result, when the motor is actuated, the spindle of the motor will drive the upper shaft to rotate and then the upper shaft drives the transversal shaft to rotate;
a lever; an upper end of the lever being retained to a distal end of the transversal shaft by using a lever bearing so that the lever is rotatable through 360 degrees with respect to the transversal shaft; a middle section of the lever being expanded as an expending ball; and
wherein in installation, the expending ball is received within a bowl unit; a bottom of the bowl unit has a through hole so that a lower portion of the lever below the ball passes through the through hole of the bowl unit; when the lever rotates around the transversal shaft, the bowl unit will support the ball and the lever is driven to rotate around the expanding ball supported on the bowl unit; in use, the bowl unit is installed to a middle plate; and
a heavy ball connected to a lower end of a steel rope; and an upper end of steel rope being movably connected to the lever.

4. The centrifugal dynamic power generating system using a lever structure as claimed in claim 3, wherein the middle plate is formed by steel rods.

5. The centrifugal dynamic power generating system using a lever structure as claimed in claim 3, wherein a lower end of the lever being connected to an adjustable sleeve; the lower end of the steel rope connecting the heavy ball is connected to the adjustable sleeve; the lever drives the steel rope and then the steel rope drives the heavy ball; the adjustable sleeve causes that the steel rope will not twist around the lever as the adjustable sleeve rotates with respect to the lever.

6. The centrifugal dynamic power generating system using a lever structure as claimed in claim 3, wherein the heavy ball is one of an iron ball, a steel ball, and metal balls.

7. The centrifugal dynamic power generating system using a lever structure as claimed in claim 3, wherein the centrifugal unit includes:
at least one centrifugal shaft; one end of the centrifugal shafts being installed with a weight which is connected to the heavy ball by another steel rope; when the heavy ball is driven to rotate by the lever, the weight will rotate therewith; therefore, the whole centrifugal unit rotates; and
a lower shaft having one end connected to a center portion of the centrifugal unit; another end of the lever being received in a retainer seat with a bearing therein so that the lower shaft can be rotatably retained to the retaining seat.

8. The centrifugal dynamic power generating system using a lever structure as claimed in claim 7, wherein there are two centrifugal shafts; and the two centrifugal shafts run across one another so as to have a cruciform.

9. The centrifugal dynamic power generating system using a lever structure as claimed in claim 7, wherein the power generating unit includes:
a gear set installed to a lower end of the lower shaft; the gear set being formed by using a longitudinal gear to engage with a transversal gear; the umbrella gear being connected to one end of a driving shaft;
a driving flywheel connected to another end of the driving shaft; an outer edge of the driving flywheel being encircled by one end of a belt; rotation of the driving flywheel will drive the belt to run circularly; and
a power generator having a generator spindle which is encircled by another end of the belt; rotation of the belt will drive the generator spindle to rotate to cause electric power is induced from the power generator.

10. The centrifugal dynamic power generating system using a lever structure as claimed in claim 9, wherein the transversal gear is an umbrella gear.
